(19) United States
(12) Patent Application Publication
(10) Pub. No.: US 2016/0152350 A1
(43) Pub. Date: Jun. 2, 2016

(54) LOCATING LUGGAGE WITH RFID TAGS

(71) Applicant: The Boeing Company, Chicago, IL (US)

(72) Inventors: Antonio F. Puentes, Frankfurt (DE); Matthew B. Hendrian, Aurora, CO (US); Nima Barraci, Frankfurt (DE); Brian A. Azcuenaga, Castle Rock, CO (US)

(73) Assignee: THE BOEING COMPANY, Chicago, IL (US)

(21) Appl. No.: 14/557,430

(22) Filed: Dec. 1, 2014

(51) Int. Cl. B64F 1/36; G08B 5/36; G06Q 10/08; G06K 7/10

(52) U.S. Cl. CPC B64F 1/368; G06K 7/10376; G08B 5/36; G06Q 10/08; G06K 2007/10504; G06Q 50/30

(57) ABSTRACT

A device comprises an RFID tag, and an electrolurninescent layer on a surface of the RFID tag. The RFID tag causes the electroluminescent layer to glow in response to an interrogation signal.

### BACKGROUND

A bag-match program such as “Positive Passenger Bag Matching” ensures that no checked baggage is placed aboard an aircraft unless the passenger who checked the baggage is aboard the aircraft. Airlines are required to remove the baggage of any passenger who checks in for a specific flight, but fails to enter the aircraft before departure. Airlines are also required to remove the baggage of any passenger who has already boarded an aircraft but then leaves the aircraft prior to departure.

If the baggage is stored in the aircraft's cargo bay, it must be located and removed from the cargo bay. Typically, ramp personnel climb inside the cargo bay and search every baggage tag for the exact item sought.

However, finding a specific item of baggage in a cargo bay takes time. Cargo bays are cramped and difficult to move around. They are poorly lit or dark. Most times, baggage is not piled in any particular order. Certain items might have to be removed in order to access other items. Additional cargo bays might have to be searched.

While each item is being located, the aircraft sits on a tarmac. If the aircraft sits too long, its time slot might be missed. A missed time slot can also result in costly departure and arrival delays. Substantial delay costs may be incurred for air crews and ground personnel. Substantial delay costs may also be incurred due to passenger misconnections and “knock-on” delays, which are compounded by any delay.

There is a need to quickly identify specific items of baggage in a cargo bay.

### SUMMARY

According to an embodiment herein, a device comprises an RFID tag, and an electroluminescent layer on a surface of the RFID tag. The RFID tag causes the electroluminescent layer to glow in response to an interrogation signal.

According to another embodiment herein, a locating system for a plurality of items comprises a plurality of glowable devices. Each glowable device includes a passive RFID tag and, an electroluminescent layer on a surface of the RFID tag. Each glowable device is secured to one of the items. The locating system further comprises an RFID reader for selectively interrogating the RFID tags. A selected RFD tag causes its surface-mounted electroluminescent layer to glow.

According to another embodiment herein, a method comprises visually locating an item stored in an aircraft. The item is tagged with a device including an electroluminescent layer that is operated by an RFID tag when the RFID tag is interrogated. Locating the item includes using an RFID reader to interrogate the RFID tag, and visually locating a glow.

These features and functions may be achieved independently in various embodiments or may be combined in other embodiments. Further details of the embodiments can be seen with reference to the following description and drawings.

### BRIEF DESCRIPTION OF THE DRAWINGS

FIG. 1 is an illustration of an apparatus including a passive RFID tag, and an electroluminescent layer on a surface of the RFID tag.

FIG. 2 is an illustration of system for using the apparatus of FIG. 1 to locate an item.

FIG. 3 is an illustration of a display for an RFID reader of the system.

FIG. 4 is an illustration of a method of using the system of FIG. 2 to locate an item of baggage in a cargo bay of an aircraft.

### DETAILED DESCRIPTION

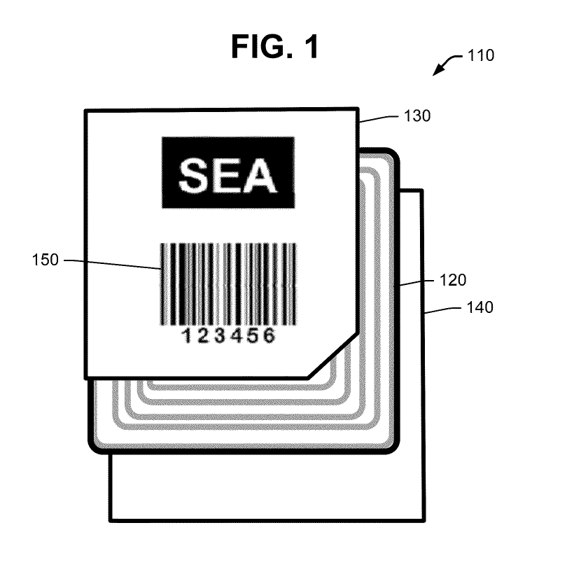

Referring to FIG. 1, a glowable device 110 includes an RFD tag 120, and an electroluminescent layer 130 on a surface of the RFD tag 120. As a first example, the electroluminescent layer 130 may include electroluminescent (EL) ink on a dielectric layer. For instance, the electroluminescent ink and a layer of silver electrode may be silkscreened on the dielectric sheet. As a second example, the electroluminescent layer 130 may include a sheet of electroconductive paper that glows when excited.

The RFID tag 120 may include standard components such as a processor, machine-readable memory, transceiver, and antenna. The RFID device may be interrogated by broadcasting an interrogation signal.

The RFID tag 120 may be active or passive. When a passive RFID tag 120 receives the interrogation signal, it harvests power from the interrogation signal and uses the harvested power for operation. An active RFID tag 120 also receives an interrogation signal, but supplies its own power for operation. For instance, the active RFID tag 120 may carry its own battery.

The operation of the RFID tag 120 includes energizing the electroluminescent layer 130, which causes the electroluminescent layer 130 to glow. Thus, the RFID tag 120 causes the electroluminescent layer 130 to glow in response to an interrogation signal.

The glowable device 110 is configured to be secured to an item. For example, the glowable device 110 may further include an adhesive layer 140 on an opposite surface of the RFID tag 120. The adhesive layer 140 may be used to secure the RFID tag 120 to an item.

The glowable device 110 may further include printed information 150 on the electroluminescent layer 130. The printed information 150 may be provided on a label, which is adhered to a front surface of the electroluminescent layer 130, or the printed information 150 may be printed directly on the electroluminescent layer 130. FIG. 1 provides examples of the printed information 150, which includes a bar code.

The glowable device 110 may be used to identify items in dark places. Even though the amount of energy generated by the RFID tag 120 is relatively low, it is sufficient to cause the electroluminescent layer 130 to create a detectable glow in a dark setting.

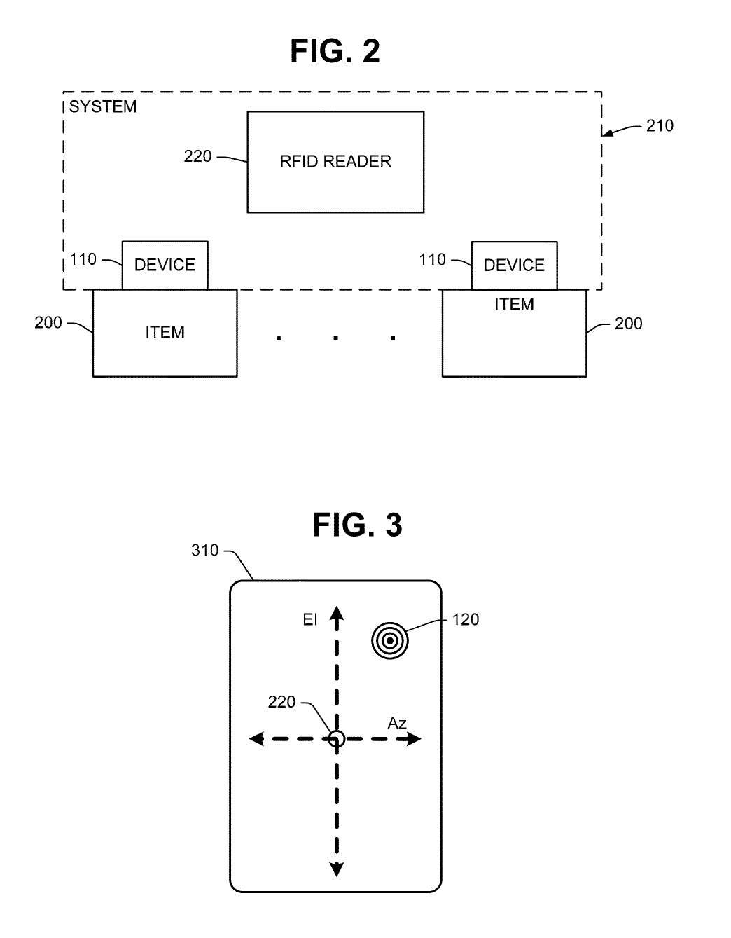

Reference is made to FIG. 2, which illustrates a locating system 210 including a plurality of the devices 110 for locating a plurality of items 200. The RFID tag 120 of each glowable device 110 may be programmed with a unique tag identifier (ID). Each glowable device 110 is configured to be secured to a corresponding one of the items 200.

The locating system 210 further includes an RFID reader 220 for selectively interrogating the RFID tags 120. The RFID reader 220 may be handheld. “Selectively interrogating” refers to interrogating all RFID tags 120 within range of the RFID reader 220, but causing only a selected RFID tag 120 (or selected RFID tags 120) to respond. For instance, the interrogation signal may contain one or more tag identifiers. Each RFID tag 120 within range of the RFID reader 220 receives the interrogation signal. An RFID tag 120 takes an action if its unique tag ID matches a tag identifier in the interrogation signal. The action includes energizing its electroluminescent layer 130 to cause it to glow.

The action may also include transmitting a tag response back to the RFID reader 220. The RFID reader 220 may use that response to determine the position of the RFID tag 120 relative to the RFID reader 220. For instance, the RFID reader 220 may use measurements of receive signal strength indication (RSSI) to determine the relative position of the transmitting RFID tag 120.

The RFID reader 220 may identify relative elevation and azimuth of the transmitting RFID tag 120. The azimuth and elevation may be identified according to polarization of the tag response.

The RFID reader 220 may include a display device and a processor programmed to identify and display a location of the transmitting RFID tag 120 relative to the RFID reader 220. Thus, the display device also shows the location of the item 200 to which the transmitting RFID tag 120 is secured. That is, the display device locates the item 200 being sought.

FIG. 3 illustrates an example of a display 310 on the display device. The display 310 presents lines corresponding to azimuth (Az) and elevation (El). The RFID reader 220 may be located at the intersection of these lines. The location of the transmitting RFID tag 120 is displayed on the display device. As the RFID reader 220 is moved relative to the transmitting RFID tag 120, the relative location is updated on the display 310.

The locating system 210 is not limited to identifying any particular item 200. Examples of items 200 include, but are not limited to, recalled or expired food in a warehouse, time-limited ammunition in storage, and medicine and safety equipment with expiration dates. However, one particular application for the locating system 210 is identifying specific items of baggage in a cargo bay of an aircraft.

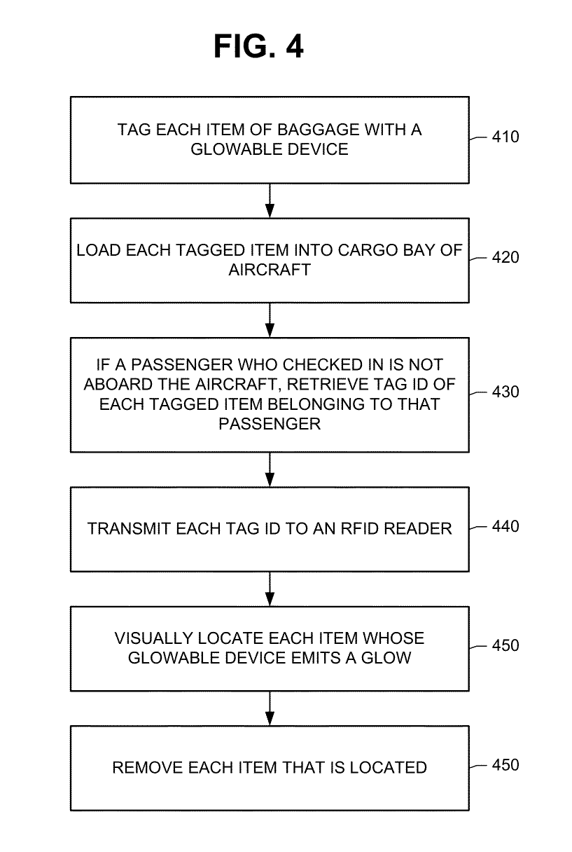

Reference is made to FIG. 4, which illustrates a method of using the locating system 210 to locate specific items 200 of baggage in a cargo bay of an aircraft. At block 410, each item 200 of baggage is tagged with a glowable device 110. For instance, a glowable device 110 is secured to an item 200 during passenger check-in. Prior to securing the glowable device 110, a printer may print out a bar code and other information directly on the electroluminescent layer 130, or the printer may print out the information on a label, which is affixed to the electroluminescent layer 130.

In addition, information including passenger name, tag ID, and aircraft may be entered into a passenger name record (PNR) database. In some instances, the RFID tag 120 may be field programmable, whereby a computer programs a unique tag ID into the RFID tag 120 and enters the unique tag ID in the PNR database. In other instances, the RFID tag 120 is read-only and has a pre-programmed tag ID, whereby the computer reads the tag ID and enters it in the PNR database.

At block 420, each tagged item 200 is routed through the airport to an aircraft. Each tagged item 200 is loaded into the cargo bay of an aircraft.

At some point following check in, a determination is made that the passenger who checked baggage is not aboard the aircraft. This determination may be made during boarding, when each boarding pass is scanned. If a passenger who checked in with baggage has not boarded the aircraft, the flight/gate manager may notify the captain who makes a decision to wait or to unload that passenger's baggage. If a decision is made to unload, the tag IDs of all items belonging to that passenger are retrieved from the PNR database (block 430).

At block 440, each retrieved tag identifier is transmitted to an RFID reader 220. The RFID reader 220 may be operated by cargo handling or other party responsible for removing each one of the passenger's items 200 from the cargo bay of the passenger's aircraft.

At block 450, each tagged item 200 belonging to the passenger is visually located in the cargo bay. Locating a tagged item 200 includes pointing an RFID reader 220 at the cargo bay, using the RFID reader 220 to generate an interrogation signal containing the tag identifier, and looking for a glow in the cargo bay. If the RFID reader 220 can display a location of the transmitting RFID tag 120 relative to the RFID reader 220, the field of search can be narrowed.

At block 460, after a tagged item 200 has been located, it may be removed from the cargo bay.

If the passenger has multiple items 200 of baggage, the RFID reader 220 can interrogate the RFID tags 120 sequentially (and locate/remove one item at a time), or the RFID tags 120 can be interrogated at the same time. For instance, if all of the RFID tags 120 have the same unique identifier, all of the glowable devices 110 will emit a glow during interrogation.

An active RFID tag offers additional advantages over a passive RFID tag. One advantage is being able to pinpoint its exact location (through triangulation) at any point of the airport over several hundred meters.

In some configurations, an RFID tag 120 may also respond to an interrogation signal by generating an audible noise. In an airport, however, the audible noise may not be effective in helping to locate the RFID tag 120, as it would echo in a cargo bay and it might be drowned out by exterior noise.

The locating system 210 is not limited to locating items 200 of a passenger who checked baggage but is not aboard an aircraft. For example, the system 210 may be used to improve the efficiency of off-loading baggage after an aircraft has landed. Tagged items 200 may be located and removed after landing for passengers with very short connections (e.g., short connecting flight periods). Baggage that is lower priority or continuing on to the final destination may be off-loaded last.

The locating system 210 may also be used to find specific items in other parts of an aircraft. The locating system 210 may be used to find items 200 not immediately visible, such as oxygen generators behind panels, specific life vests under seats, and bags in overhead storage.

1. A device comprising:
an RFID tag; and
an electroluminescent layer on a surface of the RFID tag, the RFID tag causing the electroluminescent layer to glow in response to an interrogation signal.

2. The device of claim 1, wherein the RFID tag harvests energy from the interrogation signal to energize the electroluminescent layer.

3. The device of claim 1, further comprising an adhesive layer on an opposite surface of the RFID tag.

4. The device of claim 1, further comprising printed identification information on the electroluminescent layer.

5. A locating system for a plurality of items, the system comprising:
a plurality of glowable devices, each glowable device including a passive RFID tag and, an electroluminescent layer on a surface of the RFID tag, each glowable device secured to one of the items; and
an RFID reader for selectively interrogating the RFID tags;
wherein a selected RFID tag causes its surface-mounted electroluminescent layer to glow.

6. The system of claim 5, wherein the RFID reader includes a display and a processor programmed to identify and display a location of each RFID tag that transmits a response to the RFID reader.

7. The system of claim 5, wherein each RFID tag harvests energy from an interrogation signal to energize its surface-mounted electroluminescent layer.

8. The system of claim 5, wherein each glowable device further includes an adhesive layer on an opposite surface of the RFID tag.

9. The system of claim 5, wherein each glowable device further includes printed identification information on the electroluminescent layer.

10. A method comprising visually locating an item stored in an aircraft, the item tagged with a device including an electroluminescent layer that is operated by an RFID tag when the RFID tag is interrogated, wherein locating the item includes:
using an RFID reader to interrogate the RFID tag; and
visually locating a glow.

11. The method of claim 10, further comprising removing from the aircraft the item whose device emits a glow.

12. The method of claim 10, wherein the item is stored in a cargo bay of the aircraft; and wherein using the RFID reader includes:
receiving a tag identifier of each item belonging to a passenger who checked in but is not aboard the aircraft;
pointing the RFID reader at the cargo bay prior to departure of the aircraft; and
transmitting an interrogation signal towards the cargo bay.

13. The method of claim 12, wherein the RFID reader is used to determine and display azimuth and elevation of the RFID tag after the RFID tag transmits a tag response to the RFID reader.

14. The method of claim 12, further comprising looking up the tag identifier in a passenger name record (PNR) database.

15. The method of claim 10, wherein the item is stored in a cargo bay of the aircraft; and wherein using the RFID reader includes:
receiving a tag identifier corresponding to a passenger with a short connection;
pointing the RFID reader at the cargo bay after the aircraft has landed; and
transmitting an interrogation signal towards the cargo bay.
